(19) United States
(12) Patent Application Publication
(10) Pub. No.: US 2007/0225065 A1
(43) Pub. Date: Sep. 27, 2007

(54) Method and Apparatus for Providing a Plurality of Games

(75) Inventors: Dean Wright, New South Wales (AU); Stephen Cowan, New South Wales (AU)

Correspondence Address: STERNE, KESSLER, GOLDSTEIN & FOX P.L.L.C., 1100 NEW YORK AVENUE, N.W., WASHINGTON, DC, 20005, US

(73) Assignee: Paltronics Australasia Pty Limited, Taren Point (AU)

(21) Appl. No.: 11/579,663

(22) PCT Filed: May 10, 2005
(86) PCT No.: PCT/AU05/00670

§ 371 Date: Nov. 7, 2006

(30) Foreign Application Priority Data
May 10, 2004 (AU) 2004902465

(51) Int. Cl. A63F 13/12

(52) U.S. Cl. 463/25; 463/1

(57) ABSTRACT

The gaming system (101) comprises a number of gaming machines (103) in communication with an auxiliary game controller (105) via a network (107). Each gaming machine (103) comprises a screen (111) for displaying a second game, also referred to as a base game, that the terminal (103) offers, and a set of user controls (113) through which a user inputs their choices in the running of the base game. Each gaming machine (103) has a payment port (115) such as a coin slot or electronic card reader to enable the user to pay for the base game to be played. In return for a user submitting a suitable payment via the payment port (115) the gaming machine (103) enables the user to play the base game, which is a game of chance and may result in the user winning a prize. The base game is designed to pay out in prizes a percentage of what users pay in over a predetermined number of game plays i.e. the Return To Player % (RTP %).

The present invention relates to an apparatus and method for providing a plurality of games.

The invention has been developed primarily for use with a gaming machine or a plurality of interlinked gaming terminals in one or more gaming establishments and will be described hereinafter predominantly with reference to this application. However, the invention is not limited to that particular field of use and is also suitable for use with online gaming, lotto, pools, lotteries, art unions, bingo, raffles and other games involving one or more wagers being placed upon an outcome having a finite probability of occurring. Additionally, the invention is applicable to any type of gaming, such as gaming that may be entered into on a personal computer via the Internet, for example.

### BACKGROUND

The discussion of the prior art within this specification is to assist the addressee understand the invention and is not an admission of the extent of the common general knowledge in the field of the invention and is included without prejudice.

It is known to “link” gaming terminals to provide a number of additional functionalities. This includes the ability to control the awarding of a prize, as the pool of available funds is greater and the amount of funds available is known rather than having to be estimated. Another functionality of interlinked gaming terminals is that secondary gaming is possible. For example, for a given group of interlinked gaming terminals, a central display provides the gamers with a visual indication of a presently available jackpot prize that is being incrementally increased as the gamers operate the interlinked gaming terminals.

It is known by the gamers that the prize will be awarded when it is incremented to a randomly selected value that is less than a predefined value. Typically, the predefined value will also be visually indicated to the gamers by the display. The use of such functionality is intended to provide additional impetus to the gamers to play the terminals and thereby win the jackpot prize in addition to any prize available to be awarded by the respective terminal.

It is known in gaming systems to specify the proportion of what a player inputs to a game that is returned to that player. This measure is referred to as the Return to Player (RTP) amount and is expressed as a percentage of the player input i.e. as the RTP percentage. The RTP can be described as the proportion of the value input by a player that contributes to the prizes paid out by the machine. The actual value of the RTP is determined by the attributes of the gaming device itself i.e. the likelihood of a winning combination accruing within a specified time period. Where the gaming device is a so called a “pokie” or “fruit” machine, the RTP % is determined by the probability of the winning combinations of symbols occurring on the reels over a given time. The RTP % is calculated with reference to a cycle, which is the number of unique sequences of symbols that the machine is capable of generating.

As noted above, gaming machines may be linked to other such machines to provide secondary gaming facilities such as a communal jackpot i.e. a jackpot that can be won by playing any one of an associated group of machines. The communal jackpot is available over and above the possible prizes from the base game being played on each individual machine. In this situation the RTP % is split between the base game and the communal game. The manufacturers of the gaming system traditionally determine the proportion of the split.

Many gaming systems are governed by laws which may be different from one jurisdiction to another. Commonly these laws require a minimum RTP % for a particular category of game. Also, when games are linked to other games the overall RTP % for the linked games as a whole must provide the defined RTP % threshold. When new games are created, their performance may be difficult to establish theoretically as their actual performance may be erratic or volatile. This results in large overheads in establishing the exact performance of games before they can be installed. It is highly risky to install a new game into a complex gaming system when the new game has not been sufficiently tested.

### SUMMARY OF THE INVENTION

It is an object of the present invention to overcome or ameliorate at least one of the disadvantages of the prior art, or to provide a useful alternative.

According to a first aspect of the present invention there is provided a method for providing a plurality of games, each game having a measurable performance that determines prizes awarded to a user, comprising the steps of:
providing a first game having controllable performance over a variable period of time; and
providing a second game, associated with the first game, the second game having a predetermined performance over a predetermined number of game plays.

In a preferred embodiment the method comprises the further step of controlling the performance of the first game in dependence on an element of the performance of the second game. Preferably the element of performance of the second game is the turnover of the second game. Alternatively the element of performance of the second game is the prizes awarded in the second game over a given time. Alternatively the element of performance is the number of game plays of the second game over a given time. In some embodiments a plurality of elements of the performance of the second game are used in the control of the performance of the first game.

In another embodiment, the performance of the first game is controlled in response to a random trigger or a time dependent trigger. Preferably the performance of the first game in response to the trigger continues for a predetermined time. In another preferred embodiment the performance of the first game continues until the first game has awarded a prize total equal to, or exceeding, a predetermined amount of funds. In a further embodiment the second game is linked to a third game. Preferably the third game has predetermined performance over a predetermined number of game plays.

In some embodiments the first and second games are provided by the same gaming machine. In another embodiment the second game is provided by a gaming machine and the first game is provided by a collocated apparatus. In some embodiments the second game is provided by a gaming machine and the first game is provided by a remote apparatus. In a further embodiment the control of the first game is carried out in accordance with a set of parameters. Preferably the set of parameters can be reset remotely. In other embodiments the first game is provided from a remote source over a network. In further embodiments the first game is provided in response to the award of a prize for the second or third game to another user.

In a preferred embodiment the first game is provided by a first game processor communicatively connected to first game memory and the second game is provided by a second game processor. Preferably the first game processor and the first game memory are each disposed on an interface card. Also preferably, the interface card and the second game processor are each disposed within a single gaming machine, the interface card communicatively connecting the first game processor to the second game processor. In this preferred embodiment, the interface card is communicatively connected to a remote controller such that software and parameters for the provision of the first game are downloadable from the remote controller to the first game memory. Once downloading of software and parameters is complete, the first game controller is capable of executing the first game without requiring further downloading of information from the remote controller to the interface card. Information is also uploadable from the interface card to the remote controller to allow the remote controller to monitor activity of the gaming machine and/or activity of the interface card. In a preferred embodiment the bonus game is a jackpot, however it will be appreciated that other types of bonus games are employed in alternative embodiments.

According to a second aspect of the present invention there is provided apparatus for providing a plurality of games, each game having a measurable performance that determines prizes awarded to a user, comprising:
first gaming means providing a game having controllable performance over a variable period of time; and
second gaming means, associated with the first gaming means and providing a game having a predetermined performance over a predetermined number of game plays.

Unless the context clearly requires otherwise, throughout the specification the words “comprise”, “comprising” and the like are to be construed in an inclusive as opposed to en exclusive sense; that is to say, in the sense of “included, but not limited to”.

### BRIEF DESCRIPTION OF THE DRAWINGS

Preferred embodiments of the invention will now be described, by way of example only, with reference to the accompanying drawings in which:

FIG. 1 is a schematic representation of a gaming system comprising gaming terminals;

FIG. 2 is a schematic representation of a bonus game panel associated with one of the gaming terminals of FIG. 1;

FIG. 3 is a schematic representation of the hardware associated with each of the gaming system of FIG. 1; and

FIG. 4 is a flow chart showing steps performed by the gaming machines of FIG. 1.

### DETAILED DESCRIPTION

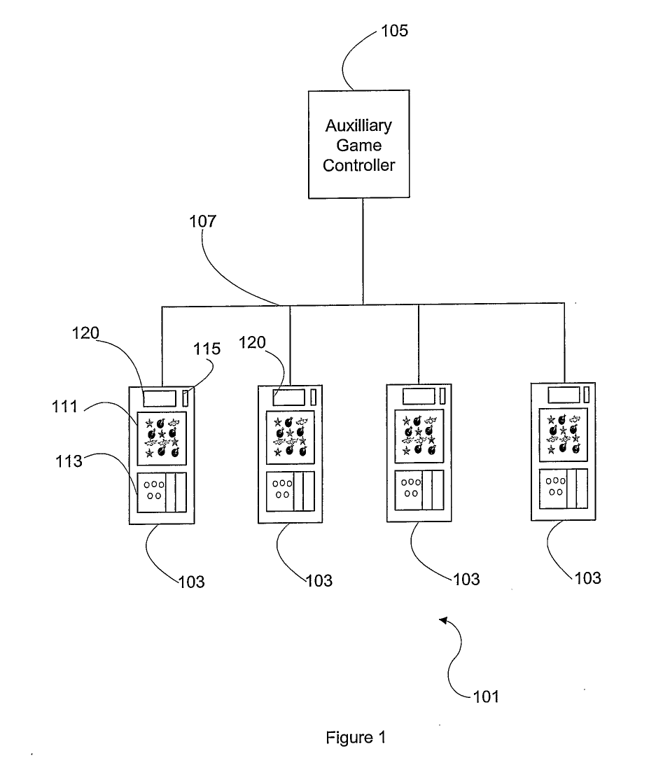

FIG. 1 shows a gaming system 101 comprising a number of gaming machines 103 in communication with an auxiliary game controller 105 via a network 107. Each gaming machine 103 comprises a screen 111 for displaying a second game, also referred to as a base game, that the terminal 103 offers, and a set of user controls 113 through which a user (not shown) inputs their choices in the running of the base game. Each gaming machine 103 has a payment port 115 such as a coin slot or electronic card reader to enable the user to pay for the base game to be played. Each gaming machine 103 also includes an interface card 120.

In return for a user submitting a suitable payment via the payment port 115 the gaming machine 103 enables the user to play the base game, which is a game of chance. The base game may result in the user winning a prize. The likelihood of a gaming machine 103 awarding a prize for a particular game play is determined by the design of the base game. The base game is designed to pay out in prizes a percentage of what users pay in over a predetermined number of game plays i.e. the Return To Player % (RTP %).

In the present embodiment, the user is provided with a first game, also known as a bonus game, which is played in conjunction with the base game. The bonus game is also a game of chance, but typically requires no user contribution in order to play the game. The bonus game may be executed automatically in conjunction with the base game. While the base game has an RTP %, there is no such measure for the bonus game. Instead, in this example, the bonus game prizes are paid from a separate bonus game prize resource under the control of the auxiliary game controller 105, as will be described in detail below.

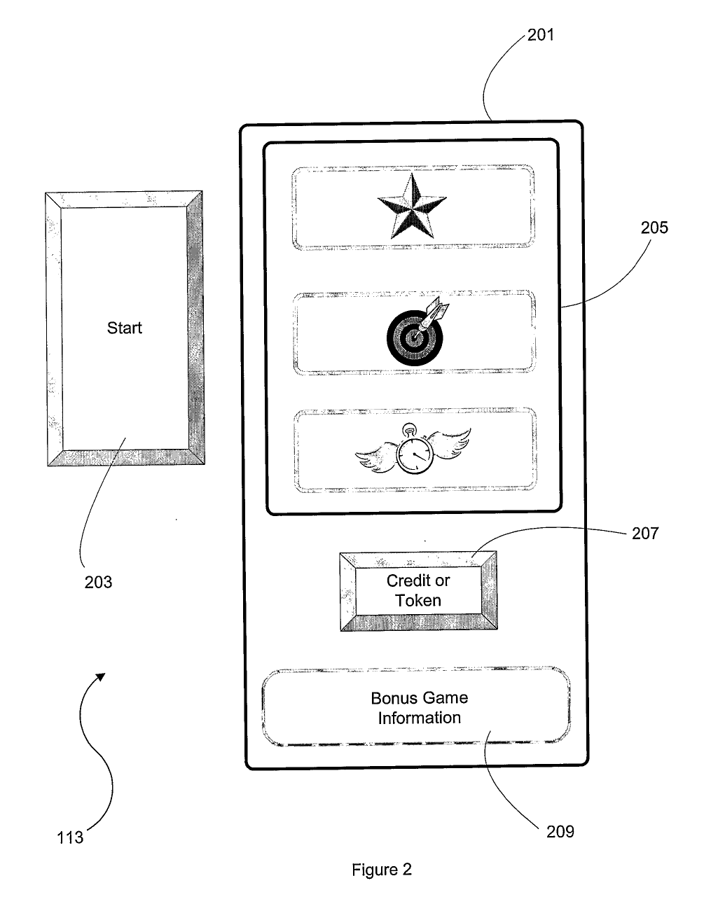

FIG. 2 shows a bonus game panel 201 associated with one of the gaming machines 103. The bonus game panel 201 is located adjacent a start button 203 of the gaming machine 103. The bonus game panel 201 comprises a three part display 205, a “Credit or Token” button 207 and an information panel 209. The display 205 is arranged to show the progress of the bonus game, which in this embodiment is started in response to the activation of the start button 203 for the base game. The base game and the bonus game play at the same time. The button 207 is operable when a prize is won in the bonus game and enables the user to select their preferred prize type. In the present embodiment the user has a choice between a token that can be redeemed against a prize or to have the monetary value of the prize transferred into credit for playing the base game. The information panel 209 contains user instructions and information for the bonus game and its prize payout.

In the present embodiment, the bonus game is represented by three symbols in the display 205 that change in response to the activation of the start button 203. If a predetermined symbol is displayed at the end of the game play, then a prize is awarded. In this embodiment, the predetermined symbol is the star symbol as shown in FIG. 2 in the upper portion of the display 205. The bonus game appears to the user to be a game with a random chance of winning. However, the bonus game is arranged to provide a predetermined value of prizes over a predetermined time. For example, the operator of the preferred embodiment may configure it to run a promotion whereby a predetermined total prize pool of, say, $5000 is awarded by the bonus game over a predetermined promotional period, for example two months. In other embodiments the performance of the bonus game may be governed by other factors such as the turnover of the gaming machine 103 as is described in detail below.

Once the predetermined time has expired, the prize value been paid out or the turnover threshold been passed then no further prizes are paid out until the bonus game is reset. In the meantime, the bonus game continues to play in conjunction with the base game but no win symbols appear in display 205. Normal circumstances for the bonus game can be defined as when the time has not run out, the prize value has not reached zero and the turnover threshold has not been passed. In these normal circumstances, useful data on the performance of the bonus game is collected which can be used to establish the likely performance of the game, for example, if it were used as a base game in a gaming machine. Outside of the normal circumstances i.e. when winning symbols are suppressed, the data may not be useful. The offering of prizes by the bonus game helps to promote the use of the game so that useful data can be gathered more quickly. The bonus game also serves to promote the use of the base game and any other connected games.

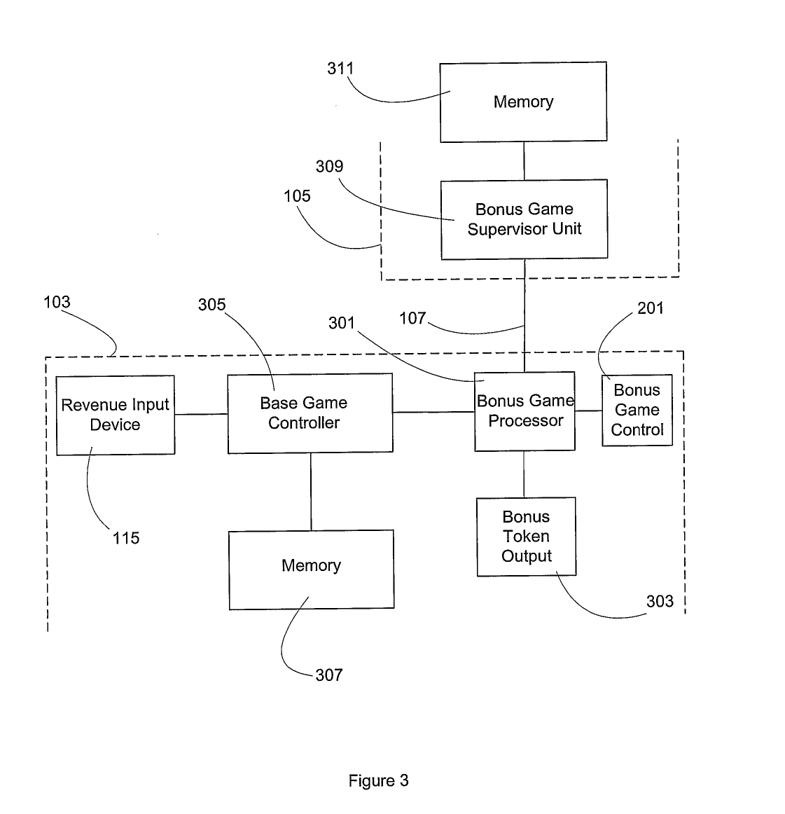

FIG. 3 illustrates a part of the hardware of the gaming machine 103 and the auxiliary game controller 105. The bonus game panel 201 is connected to a bonus game controller 301 which is connected to a token output device 303. The bonus game controller 301 is connected to a base game controller 305 which is connected to a memory 307 and the revenue input device 115. The bonus game controller 301 is also connected via the network 107 to a bonus game supervisor unit 309 in the auxiliary game controller 105. The bonus game supervisor unit is connected to a memory 311.

The revenue input device 119 is operable to accept monetary input from a user in the form of coins or notes, tokens, payment card or other suitable form of payment. The revenue input device 119 indicates the amount of the payment to the game controller 301, which responds by adding the input value to the memory 307. The memory 307 is used to store input values and log them against output prizes. The base game controller 301 is the element in the gaming machine that runs the base game in response to user commands input via the control panel 117 (FIG. 1). The base game controller 301 also controls the paying out of prizes for the base game as they are won.

The bonus game processor 301 runs the bonus game and displays the results on the bonus game control 201. When a prize is awarded in the bonus game, the bonus game processor 301 responds to the user's input via button 207 to either issue a prize token via the bonus token output device 303 or to communicate the monetary value of the prize to the base game controller 305 for addition to the users current credit for the base game. The “Credit or Token” button 207 offers each option in an alternating fashion to enable the user to make the appropriate choice between receiving a credit or a token.

A noted above, in a preferred embodiment the bonus game is designed to pay out a preset amount of prizes in a preset time. In addition, the bonus game only awards prizes when the turnover of the base game is within a set of limits. The preset time, preset prize value and the turnover thresholds are set by the control of the bonus game supervisor unit 309 over the network 107. The bonus game processor 301 is also arranged to collect data from the base game (turnover, prize payout, user behavior) along with data from the bonus game. This is transmitted to the bonus game supervisor unit 309 and stored in the memory 311. The data can then be used to determine the performance of the bonus game and its effect on user behavior.

The supervisor unit 309 is arranged to either reset the preset time, prize value or turnover thresholds periodically or under the control of the system supervisor. Also, the supervisor unit is capable of changing the game offered as the bonus game. Game programs are stored in the memory 311 and downloaded to the bonus game processor 309. The download of alternative games can be programmed to occur at certain time intervals or in response to one or more performance criteria of the base or bonus game such as turnover or level of prize payout.

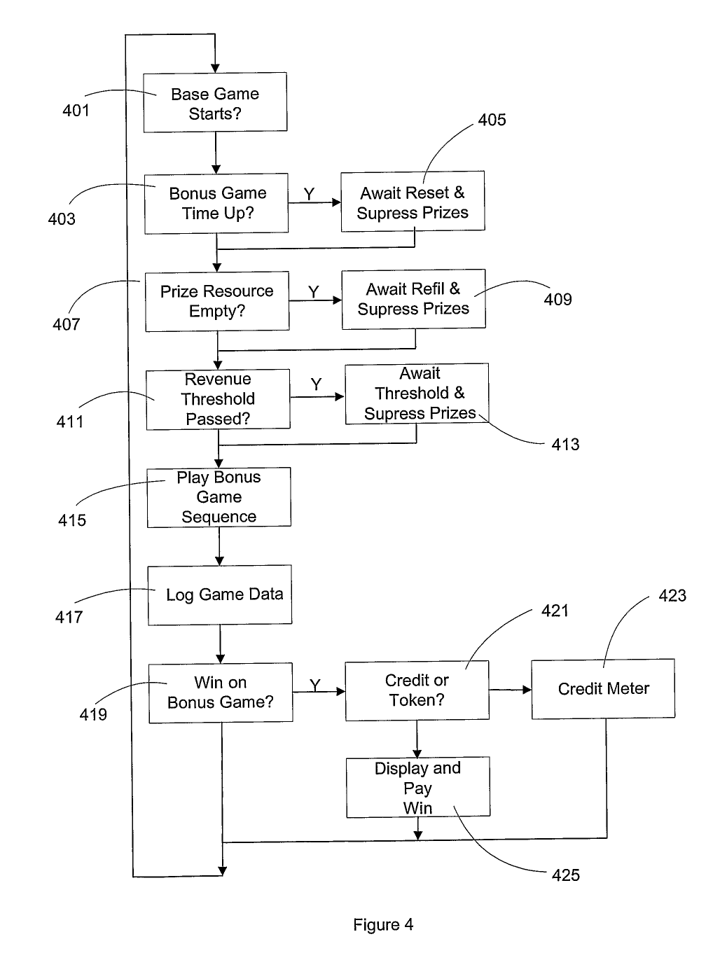

The operating process of a bonus game processor 301 in one of the gaming machines 103 will now be described with reference to the flow chart of FIG. 4. On setup, the time and prize limits are set and the revenue thresholds defined. Processing then holds at step 401 until the start button 203 is activated for the base game. Processing then moves to step 403 where a check is carried out to determine if the preset time for the bonus game to pay out prizes has expired and if so processing moves to step 405. At step 405 the processing holds until the time is reset and in the interim the bonus game continues to play but without paying out prizes. When the time is reset then processing moves to step 407. Similarly, if at step 403 the time as not expired then processing moves to step 407.

At step 407, a check is carried out to determine if the prize payout limit has been reached and if so processing moves to step 409. At step 409 the processing holds until the prize limit is reset and in the interim the bonus game continues to play but without paying out prizes. When the prize limit is reset then processing moves to step 411. Similarly, if at step 407 the prize limit as not been reached then processing moves to step 411.

At step 411, a check is carried out to determine if the turnover threshold has been reached and if so processing moves to step 413. At step 409 the processing holds until the turnover threshold is reset and in the interim the bonus game continues to play but without paying out prizes. When the turnover threshold is reset then processing moves to step 415. Similarly, if at step 411 the turnover threshold has not been reached then processing moves to step 415.

At step 415, the game sequence is played, the result displayed in the display 205 and the processing moves to step 417. At step 417, the data for the bonus game and the base game are logged and transmitted to the supervisor unit 309. Processing then moves to step 419 where if a win has occurred on the bonus game processing moves on to step 421. If no win has occurred then processing returns to step 401 and awaits a further actuation of the start button 203.

At step 421 the button 207 is activated to enable the user to choose between the prize being awarded as a credit to the base game or as a prize token. If credit is selected then processing moves to step 423 where a signal is sent to the base game controller to add the prize value to the credit meter for the base game and processing returns to step 401. If at step 421 a token is chosen then processing moves to step 425 where the bonus token output device 303 is instructed to produce the appropriate token for the user. Processing then returns to step 401 and continues as described above.

Embodiments of the invention provide a way to carry out promotional activity for a gaming system automatically and to control the time and spend of such activity.

In other embodiments, the bonus game is provided on a single gaming machine that includes the functions of the auxiliary game controller described above i.e. the bonus game is provided in a stand-alone environment. In other embodiments the bonus game may be provided without the functions of the auxiliary controller as a single use game. In other words, once the time or prize limit has expired the game cannot be reset. In another embodiment the game in the stand-alone gaming machine can be reset but the parameters of operation are not changeable.

In another embodiment the network 107 is a local or wide area network. In other embodiments the bonus game is associated with a linked gaming system where users are able to participate in more than one game at a time in addition to the bonus game. One or more of the games may be played over a network of gaming devices. In some embodiments one or more game plays of the bonus game are awarded to the user by way of consolation for missing a linked jackpot or losing an associated game.

In some embodiments the bonus game may not be physically linked to a gaming machine but distant from it. In other embodiments the bonus game is player specific with a players individual choice of game being provided in response to a user playing an associated gaming machine. In some embodiments the user's details are recorded and retrieved for use in the user's individual bonus game. The details may include user specific triggers for prize payouts such as a player specific turnover threshold, time limit or time windows, or prize limits. In some embodiments prizes may be non-monetary.

In another embodiment the bonus game functionality is provided on a computer chip installed at manufacture, or as a chip or card for post manufacture installation or by software installation or download. In one such embodiment the bonus game processor 309 and associated memory are disposed on an interface card 120, which is either installed into the gaming machine 103 at manufacture, or is retro-fitted to the gaming machine 103 post manufacture. In this preferred embodiment the bonus game processor 309 is a computer chip the form of an EPROM or a flash card, which is communicatively connected by the interface card 120 to the electronics of the gaming machine 103 (i.e. the computer chip is communicatively connected to the electronics that are responsible for the provision of the base game). In this embodiment the software necessary for the running of the bonus game, including any of the associated game parameters (for example the total amount of funds available to be awarded by the bonus game), is downloaded from the memory 311 of the remote controller 105 (which is also referred to in this document as an auxiliary game controller 105) to the memory on interface card 120. Once downloading is complete, the interface card 120, in conjunction with the computer chip and its associated memory, has sufficient information and functionality to allow for execution of the bonus game without the requirement for the receipt by the gaming machine 103 of further information from the auxiliary game controller 105 (at least until such time as software and/or parameters for an alternative bonus game are downloaded from the auxiliary game controller 105 to the gaming machine 103). From this point onwards information is uploaded from the interface card to the auxiliary game controller 105 so as to allow the auxiliary game controller 105 to monitor the activity of the gaming machine 103 and/or the activity of the interface card. In this embodiment of the invention each bonus game is initiated at the gaming machine 103 level, without the requirement for the auxiliary game controller 105 to trigger the execution of each bonus game. In one embodiment execution of the bonus game is manually initiated by the player of the gaming machine. In another embodiment, execution of the bonus game is synchronized with execution of the base game.

Any game can be used as a bonus game as long as the outcome can be predetermined so that the game pays out the required amount of prizes within a given time if applicable. The bonus game can be used to trial new games to establish their actual performance as opposed to their theoretical performance and collect data on user's response to those games. In one preferred embodiment the bonus game is a jackpot. To operate the jackpot the computer chip on the interface card 120 is utilised to generate a random number that lies within a range of numbers associated with the gaming machine 103. If the randomly generated number is equal to the number associated with the gaming machine, then the jackpot prize is awarded. In the preferred embodiment the number associated with the gaming machine 103 is provided by one of the meters of the gaming machine 103. For example, the meter selected to provide the number associated with the gaming machine 103 has a range of 1 to 9,999,999; hence the computer chip on the interface card 120 is programmed to generate a random number between 1 and 9,999,999 inclusive. The computer chip on the interface card 120 then compares the randomly generated number with the number provided by the selected gaming machine meter and awards the jackpot if the two numbers are equal.

As a post-manufacture addition to a gaming system, embodiments of the present invention may extend the life of a gaming machine. Use of the system embodying the invention and observation of user behavior may provide the operator with a better understanding of the players' preferences and the game's performance enabling improved marketing and design of future gaming systems.

In further embodiments, the information panel of the bonus game control may be provided separately from the panel itself or absent. The information panel may be arranged to reveal or “pop up” when requested by a user. The control panel may be provided using any combination of traditional switches and displays or touch screens and so called “soft buttons”. The hardware block arrangements and software steps used in the above description and respective figures may be varied to suit different applications. The functionally described hardware blocks and software steps may be joined, split or modified. The split control feature may be provided as a software and/or hardware upgrade to the design of existing gaming machines.

It will be understood by those skilled in the art that the apparatus that embodies a part or all of the present invention may be a general purpose device having software arranged to provide a part or all of an embodiment of the invention. The device could be single device or a group of devices and the software could be a single program or a set of programs. Furthermore, any or all of the software used to implement the invention can be communicated via various transmission or storage means such as computer network, floppy disc, CD-Rom or magnetic tape so that the software can be loaded onto one or more devices.

Although the invention has been described with reference to specific embodiments, it will be appreciated by those skilled in the art that it may be embodied in other forms.

1. A method for providing a plurality of games, each game having a measurable performance that determines prizes awarded to a user, comprising the steps of:
providing a first game having controllable performance over a variable period of time; and
providing a second game, associated with the first game, the second game having a predetermined performance over a predetermined number of game plays.

2. A method according to claim 1 further comprising the step of controlling the performance of the first game in dependence on an element of the performance of the second game.

3. A method according to claim 2 in which the element of performance of the second game is the turnover of the second game.

4. A method according to claim 2 in which the element of performance of the second game is the prizes awarded in the second game over a given time.

5. A method according to claim 2 in which the element of performance is the number of game plays of the second game over a given time.

6. A method according to claim 2 in which a plurality of elements of the performance of the second game are used in the control of the performance of the first game.

7. A method according to claim 1 in which the performance of the first game is controlled in response to a random trigger or a time dependent trigger.

8. A method according to claim 7 in which the control of the performance of the first game in response to the trigger continues for a predetermined time.

9. A method according to claim 1 in which of the performance of the first game continues until the first game has awarded a prize total equal to, or exceeding, a predetermined amount of funds.

10. A method according to claim 2 in which the second game is linked to a third game.

11. A method according to claim 10 in which the third game has predetermined performance over a predetermined number of game plays.

12. A method according to claim 1 in which the first and second games are provided by a single gaming machine.

13. A method according to claim 1 in which the second game is provided by a gaming machine and the first game is provided by a collocated apparatus.

14. A method according to claim 1 in which the second game is provided by a gaming machine and the fast game is provided by a remote apparatus.

15. A method according to claim 1 in which the control of the first game is carried out in accordance with a set of parameters.

16. A method according to claim 14 in which the set of parameters can be reset remotely.

17. A method according to claim 1 in which the first game is provided from a remote source over a network.

18. A method according to claim 1 wherein the first game is provided by a first game processor communicatively connected to first game memory and wherein said second game is provided by a second game processor.

19. A method according to claim 18 wherein said first game processor and said first game memory are each disposed on an interface card.

20. A method according to claim 19 wherein said interface card and said second game processor are each disposed within a single gaming machine, said interface card communicatively connecting said first game processor to said second game processor.

21. A method according to claim 18, wherein said interface card is communicatively connected to a remote controller such that software and parameters for the provision of the first game are downloadable from the remote controller to the first game memory.

22. A method according to claim 21, wherein, once downloading of software and parameters is complete, the first game controller is capable of executing the first game without requiring further downloading of information from the remote controller to the interface card.

23. A method according to claim 21 wherein information is uploaded from the interface card to said remote controller, thereby allowing said remote controller to monitor activity of the gaming machine and/or activity of the interface card.

24. A method according to claim 1 wherein the first game is a jackpot.

25. Apparatus for providing a plurality of games, each game having a measurable performance that determines prizes awarded to a user, comprising:
first gaming means providing a game having controllable performance over a variable period of time; and
second gaming means, associated with the first gaming means and providing a game having a predetermined performance over a predetermined number of game plays.

26. Apparatus according to claim 25 in which the performance of the first game is controlled in dependence on an element of the performance of the second game.

27. Apparatus according to claim 26 in which the element of performance of the second game is the turnover of the second game.

28. Apparatus according to claim 26 in which the element of performance of the second game is the prizes awarded in the second game over a given time.

29. Apparatus according to claim 26 in which the element of performance is the number of game plays of the second game.

30. Apparatus according to claim 26 in which a plurality of elements of the performance of the second game are used in the control of the performance of the first game.

31. Apparatus according to claim 25 in which the performance of the first game is controlled in response to a random trigger or a time dependent trigger.

32. Apparatus according to claim 31 in which the control of the performance of the first game in response to the trigger continues for a predetermined time.

33. Apparatus according to claim 26 in which the second game is linked to a third game.

34. Apparatus according to claim 33 in which the third game has predetermined performance over a predetermined number of game plays.

35. Apparatus according to claim 25 in which the first and second games are provided by the same gaming machine.

36. Apparatus according to claim 25 in which the second game is provided by a gaming machine and the first game is provided by a collocated apparatus.

37. Apparatus according to claim 25 in which the second game is provided by a gaming machine and the first game is provided by a remote apparatus;

38. Apparatus according to claim 25 in which the control of the first game is carried out in accordance with a set of parameters.

39. Apparatus according to claim 38 in which the set of parameters can be reset remotely.

40. Apparatus according to claim 25 in which the first game is provided from a remote source over a network.

41. Apparatus according to claim 25 wherein the first game is provided by a first game processor communicatively connected to first game memory and wherein said second game is provided by a second game processor.

42. Apparatus according to claim 25 wherein said first game processor and said first game memory are each disposed on an interface card.

43. Apparatus according to claim 19 wherein said interface card and said second game processor are each disposed within a single gaming machine, said interface card communicatively connecting said first game processor to said second game processor.

44. Apparatus according to claim 18, wherein said interface card is communicatively connected to a remote controller such that software and parameters for the provision of the first game are downloadable from the remote controller to the first game memory.

45. Apparatus according to claim 44, wherein, once downloading of software and parameters is complete, the first game controller is capable of executing the first game without requiring further downloading of information from the remote controller to the interface card.

46. Apparatus according to claim 44 wherein information is uploaded from the interface card to said remote controller, thereby allowing said remote controller to monitor activity of the gaming machine.

47. Apparatus according to claim 25 wherein the first game is a jackpot.

48. (canceled)

49. (canceled)
